(19) United States
(12) Patent Application Publication
(10) Pub. No.: US 2025/0165701 A1
(43) Pub. Date: May 22, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Taichi FURUKAWA, Tokyo (JP)

(21) Appl. No.: 18/945,357

(22) Filed: Nov. 12, 2024

(30) Foreign Application Priority Data
Nov. 20, 2023 (JP) 2023-196952

(51) Int. Cl. G06F 40/166

(52) U.S. Cl. CPC G06F 40/166

(57) ABSTRACT

An information processing apparatus according to the present application includes an acquisition unit, a determination unit, and a generation unit. The acquisition unit acquires user information that is information of each user who has performed a specific behavior in an online service. The determination unit determines a plurality of personas different from each other by clustering based on the user information acquired by the acquisition unit. The generation unit causes generative AI to generate information indicating a discussion on a specific agenda by the personas based on information indicating the personas determined by the determination unit.

### CROSS-REFERENCE TO RELATED APPLICATION

The present application claims priority to and incorporates by reference the entire contents of Japanese Patent Application No. 2023-196952 filed in Japan on Nov. 20, 2023.

### BACKGROUND OF THE INVENTION

### 1. Field of the Invention

The present invention relates to an information processing apparatus, an information processing method, and a non-transitory computer readable storage medium.

### 2. Description of the Related Art

In the related art, technologies have been proposed to automatically generate opinions and the like on agendas. For example, Japanese Patent Application Laid-open No. 2019-083040 discloses a technology of searching articles by using keywords and disputed words obtained by analyzing an input agenda, extracting sentences related to the disputed points from the articles, generating and evaluating a sentence by rearranging the sentences, and outputting the highest-rated sentence as an opinion sentence about the agenda.

However, since the techniques in the related art described above generate opinion sentences on a rule basis, appropriately generating opinion sentences for the agenda are sometimes difficult and there is room for improvement in terms of obtaining more appropriate discussions on the agenda.

### SUMMARY OF THE INVENTION

An information processing device according to the present application according to the present application includes an acquisition unit, a determination unit, and a generation unit. The acquisition unit acquires user information that is information of each user who has performed a specific behavior in an online service. The determination unit determines a plurality of personas different from each other by clustering based on the user information acquired by the acquisition unit. The generation unit causes generative AI to generate information indicating a discussion on a specific agenda by the personas based on information indicating the personas determined by the determination unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to an embodiment;

FIG. 2 is a diagram illustrating an example of the configuration of an information processing system according to an embodiment;

FIG. 3 is a diagram illustrating an example of the configuration of an information processing apparatus according to an embodiment;

FIG. 4 is a diagram illustrating an example of a user information table stored in a user information storage unit of the information processing apparatus according to an embodiment;

FIG. 5 is a diagram illustrating an example of discussion information provided to a user by a providing unit in a processing unit of the information processing apparatus according to an embodiment;

FIG. 6 is a diagram illustrating another example of discussion information provided to a user by the providing unit in the processing unit of the information processing apparatus according to an embodiment;

FIG. 7 is a diagram illustrating an example of mind map information provided to a user by the providing unit in the processing unit of the information processing apparatus according to an embodiment;

FIG. 8 is a flowchart showing an example of information processing performed by the processing unit of the information processing apparatus according to an embodiment; and

FIG. 9 is a hardware configuration diagram illustrating an example of a computer that implements the functions of the information processing apparatus according to an embodiment.

### DETAILED DESCRIPTION OF THE PREFERRED EMBODIMENTS

The following is a detailed description of modes (hereinafter, referred to as “embodiments”) for implementing an information processing apparatus, an information processing method, and a non-transitory computer readable storage medium according to the present application, with reference to the drawings. The embodiments do not limit the information processing apparatus, the information processing method, and the non-transitory computer readable storage medium according to the present application. In addition, respective embodiments can be appropriately combined within a range in which processing content is not inconsistent. In each of the following embodiments, identical parts are marked with the same symbol and redundant descriptions are omitted.

### 1. Example of Information Processing

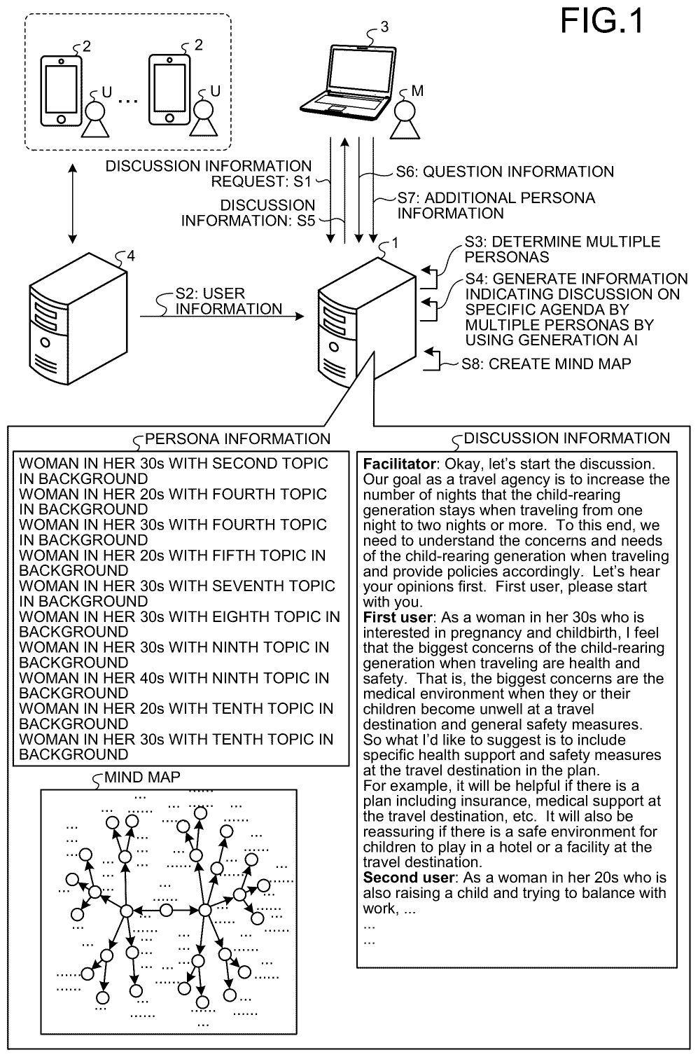

First, an example of information processing according to an embodiment is described with reference to FIG. 1. FIG. 1 is a diagram illustrating an example of information processing according to an embodiment.

An information processing apparatus 1 illustrated in FIG. 1 is an information processing apparatus for generating information indicating discussions on a specific agenda, and provides a discussion information providing service for providing information indicating the discussions on the specific agenda. The information processing apparatus 1 is implemented, for example, with one or more servers or cloud systems, or the like.

As illustrated in FIG. 1, the information processing apparatus 1 receives discussion information requests transmitted from a terminal device 3 of a user M who uses the discussion information providing service (step S1). The discussion information request includes, for example, information to be acquired, agenda information, termination condition information, constraint condition information, and the like.

The information to be acquired is information that designates information used to determine a persona at step S3 to be described below, and includes, for example, type information indicating the type of online service designated by the user M and target behavior-specific information specifying a target behavior being a behavior designated by the user M in the online service. The target behavior is an example of a specific behavior.

Types of online games include, for example, online question and answer (Q&A) services, online search services, online news providing services, online bulletin board services, and the like, which are online services provided by an information processing apparatus 4, but are not limited to such examples.

The target behavior is, for example, the use of a service in a specific category for services such as the online Q&A services, the online bulletin board services, and the online news providing services, or a search using a specific search query for online search services, but is not limited to such examples.

The use of the service in the specific category, for example, is the viewing of information (for example, information indicating a question or information indicating an answer) in the specific category in the case of the online Q&A services, but is not limited to such examples. For example, the use of the service in the specific category may be the posting of the information (for example, information indicating a question or information indicating an answer) in the specific category instead of the viewing of the information in the specific category.

The search using the specific search query is, for example, a search in the online search service using a search query including a specific search keyword, a specific phrase, or the like, but is not limited to such examples. For example, the search using the specific search query may be a search in the online Q&A service or the like using the search query including the specific search keyword, the specific phrase, or the like.

The target behavior-specific information is information indicating specific terms related to the online Q&A service, for example, information indicating one or more specific terms included in one or more categories. In this case, the use of a service of a category including the specific terms is the target behavior. In the online Q&A service, categories are represented in a hierarchical structure.

For example, the category “childbirth” is represented by a top layer “parenting and school”, a middle layer “parenting”, a bottom layer “childbirth”, and the like, but is not limited to such examples and may be represented by four or more layers or two or less layers.

For example, in the case of a category related to parenting, the specific terms include “elementary school”, “pregnancy”, “childbirth”, “early childhood education”, “kindergarten”, “daycare center”, “entrance exam”, “child”, “children”, “high school”, “home”, and the like, but are not limited to such examples.

The target behavior-specific information may be, for example, category name information, and is, for example, information of categories shown in a hierarchical structure, such as information of a character string “Parenting and school>parenting>childbirth”, but is not limited to such examples. For example, information specifying a category indicated by the target behavior-specific information may be information of the category indicated by the top layer, the middle layer, or the bottom layer.

The target behavior-specific information is, for example, information specifying a specific search query in a search service, and includes, for example, information of a specific search keyword, a specific search phrase, or the like. In this case, the target behavior is a search with a search query including the specific search keyword or the specific search phrase in whole or in part.

The agenda information is information indicating a specific agenda designated by the user M. The termination condition information is information indicating termination conditions for discussions on a specific agenda. The constraint condition information is information indicating constraint conditions for discussions by a plurality of personas determined at step S3 to be described below.

For example, it is assumed that the user M is an employee of a travel agency. In this case, the agenda is, for example, “Travel Policies for Child-rearing Generation”. The termination condition is, for example, to “summarize one specific travel policy for the child-rearing generation based on everyone's opinions”. The constraint condition is, for example, “most of the child-rearing generation stays one night on trips, so we would like to implement measures to extend one night to two nights or more. We would like you to consider measures based on the concerns and needs of the child-rearing generation when traveling”.

In addition, it is assumed that the user M is an employee of a developer. In this case, the agenda is, for example, “housing that the child-rearing generation wants to live in (custom-built houses, detached houses for sale, condominiums, and the like)”. The termination condition is, for example, “based on everyone's opinions, please determine three child-rearing support measures that would make the city a more desirable place to raise children”. The constraint condition is, for example, “we would like to know what measures the child-rearing generation requires to overcome the declining birthrate and aging population”.

In addition, it is assumed that the user M is an employee of a municipality. In this case, the agenda is, for example, “Child-rearing Support Measures”. The termination condition is, for example, “summarize three conditions for housing that the child-rearing generation wants to live in”. The constraint condition is, for example, “as a developer, I want to ascertain housing required by the child-rearing generation”.

The user M can operate the terminal device 3 to input or select the information to be acquired, the agenda information, the termination condition information, the constraint condition information, and the like. The terminal device 3 transmits, to the information processing apparatus 1, the discussion information request including the information to be acquired, the agenda information, the termination condition information, the constraint condition information, and the like input or selected by the user M.

Subsequently, the information processing apparatus 1 acquires user information, which is information of each user U who has performed the target behavior specified by the information to be acquired for the type of online service specified by the information to be acquired included in the discussion information request received at step S1, from the information processing apparatus 4, an internal storage unit, or the like (step S2).

The user information includes the attribute information and the behavior information of the user U. The attribute information of the user U is, for example, information indicating the attributes of the user U. The attributes of the user U are, for example, the demographic attributes of the user U, but may also be the psychographic attributes of the user U or a combination of the demographic attributes and the psychographic attributes of the user U.

The behavior information of the user U is information on the target behavior by the user U who performed the target behavior specified by the information to be acquired. For example, when the type of online service specified by the information to be acquired is the online Q&A service, the behavior information of the user U is information indicating the usage content of a service in a specific category being a category specified by the target behavior-specific information.

The usage content of the service in the specific category is, for example, viewing of information (for example, information indicating a question or information indicating an answer) of the specific category, posting of information (for example, information indicating a question or information indicating an answer) to the specific category, and the like, but is not limited to such examples. When the type of online service specified by the information to be acquired is the online search service, the behavior information of the user U is information indicating the content viewed by performing a search with a search query including a specific search keyword or a specific phrase indicated by the target behavior-specific information, or the like, but is not limited to such examples.

Subsequently, the information processing apparatus 1 determines a plurality of personas different from each other by clustering based on the user information of each user U acquired at step S1 (step S3).

For example, it is assumed that the type of online service indicated by the type information of the information to be acquired included in the discussion information request is the online Q&A service and a specific behavior indicated by target specific information of the information to be acquired included in the discussion information request is the use of a service in a category including specific terms.

In this case, the information processing apparatus 1 extracts a plurality of feature words from information of a specific category being the category including the specific term, and clusters the user U by dividing each specific category into topics by using latent Dirichlet allocation (LDA) from the feature words.

For example, the information processing apparatus 1 extracts, for each specific category, a plurality of feature words from the information of the specific category being the category including the specific term indicated by the target behavior-specific information. The information processing apparatus 1, for example, extracts individual words included in the information of the specific category and removes meaningless words from the extracted words.

The information processing apparatus 1 acquires feature words as vectors from the words from which the meaningless words have been removed, by using term frequency-inverse document frequency (TF-IDF), Bag-of-Words, or the like. The information processing apparatus 1 uses the LDA to determine topics of each specific category from the feature words extracted as the vectors, and performs topic classification for classifying each specific category into a corresponding topic. The information processing apparatus 1 clusters the users U by classifying the users U who have used the specific category into topics corresponding to the specific category. The clustering performed by the information processing apparatus 1 is not limited to the clustering by the LDA, but can use k-means or any other clustering method.

The information processing apparatus 1 classifies users U, who have used a specific category classified into each of a plurality of topics different from each other, into each of the topics, but can also classify the users U into a topic with the highest number of uses of the specific category, for example.

On the basis of the percentage of the users U classified into each topic, the information processing apparatus 1 extracts, as target topics, topics for which the percentage of the users U is equal to or greater than a threshold value, and determines personas corresponding to such target topics. The threshold value is 5%, but is not limited to such an example.

For example, on the basis of the attribute information of the user U classified into the target topic and target topic information that is information on the target topic, the information processing apparatus 1 determines a persona corresponding to the target topic.

For example, the information processing apparatus 1 determines, as persona information corresponding to the target topic, information including attributes having a large percentage among the attributes of the user U classified into the target topic and the information of the specific category classified into the target topic. Attributes, whose information are included in the persona information, are indicated, for example, by gender and age, but are not limited to such examples and may be indicated, for example, by family structure, annual income, place of residence, occupation, and the like, in addition to or instead of gender and age.

For example, the information processing apparatus 1 rounds off the first place of the percentage of users U belonging to a topic whose percentage of users U is equal to or greater than the threshold value, and then uses a value obtained by dividing the resultant value by 10 as the number of personas corresponding to the topic; however, the present invention is not limited to such an example.

When the number of personas corresponding to the same target topic is one, the information processing apparatus 1 sets, as the attribute of the persona, the attribute with the highest percentage among the attributes of the user U classified into the target topic. When the number of personas corresponding to the same target topic is two or more, the information processing apparatus 1 sets each of two or more attributes as the attribute of a corresponding persona out of the two or more personas in the order of the attributes with the highest percentage among the attributes of the user U classified into the target topic.

The target topic information included in the persona information is information indicating the target topic, but may also be information obtained by summarizing the information of the specific category classified into the target topic, by text generation artificial intelligence (AI) or the like.

The text generative AI is, for example, a language model trained to infer a next token from an input token sequence and output the inferred token, such as transfer-based models or recurrent neural network (RNN)-based models.

The transfer-based models are, for example, a generative pre-trained transformer (GPT), bidirectional auto regressive dialogues (BARD), and the like, but are not limited to such examples. The RNN-based models are, for example, receptance weighted key value (RWKV) and the like, but are not limited to such examples. Note that input information is desirably kept confidential, such as personal information, by learning not to use the input information as a new answer.

For example, it is assumed that topics to be classified for the user U at step S3 are first to tenth topics and the target topics are the second topic, the fourth topic, the fifth topic, and the seventh to tenth topics. In addition, it is assumed that the number of personas corresponding to the fourth topic, the ninth topic, and the tenth topic is two.

In this case, the information processing apparatus 1 determines 10 personas, for example, a woman in her 30s with the second topic in the background, a woman in her 20s with the fourth topic in the background, a woman in her 30s with the fourth topic in the background, a woman in her 20s with the fifth topic in the background, a woman in her 30s with the seventh topic in the background, a woman in her 30s with the eighth topic in the background, a woman in her 30s with the ninth topic in the background, a woman in her 40s with the ninth topic in the background, a woman in her 20s with the tenth topic in the background, and a woman in her 30s with the tenth topic in the background.

Subsequently, the information processing apparatus 1 causes the generative AI to generate information indicating discussions on a specific agenda by the personas on the basis of information indicating the personas determined at step S3 (step S4). The generative AI is the text generative AI described above or a multimodal AI.

The multimodal AI, the multimodal AI is, for example, a model that generates images from text or generates text from images, and is, for example, GPT-4-Trubo, GPT-4V, CM3Leon (Chameleon multimodal model), or the like, but is not limited to such examples.

At step S4, the information processing apparatus 1 inputs, to the generative AI as the input information, for example, information including instruction information that directs opinions on a specific agenda by the personas determined at step S3, and causes the generative AI to generate the information indicating the discussions by the personas. The specific agenda is an agenda indicated by the agenda information included in the discussion information request.

The instruction information includes, for example, agenda information indicating a specific agenda, persona information including information on each of a plurality of personas, a persona's past utterance history, output instruction information that instructs the selection of a persona to speak from the personas indicated by the persona information and the output of an utterance to a previously selected persona, and the like.

By inputting the information including the instruction information to the generative AI as the input information, the information processing apparatus 1 repeats a process of causing the generative AI to output output information including information indicating a persona selected as a next speaker and information indicating an utterance of a persona selected as a current speaker. This allows the information processing apparatus 1 to cause the generative AI to generate information indicating discussions by a plurality of personas.

When the generative AI is GPT-4 provided by OpenAI, the agenda information indicating a specific agenda, the persona information including information on each of the personas, the output instruction information, and the like are set as system message information, while the information indicating a selected persona and the persona's past utterance history are set as user prompts, but are not limited to such examples.

The instruction information includes, for example, information of a character string “The following 10 users are going to hold a discussion. The agenda and detailed information of the 10 users are as follows”, and the like, which allows the generative AI to appropriately generate the information indicating discussions by the personas. Detailed information of the users is persona information and includes topic information, attribute information, and the like as described above. The persona information may include, for example, information of a category frequently used by the user U instead of the topic information.

The information processing apparatus 1 can also input information to the generative AI as the input information, the information further including the termination condition information in the instruction information, the termination condition information being included in the discussion information request. The termination condition information is information indicating termination conditions for discussions on a specific agenda.

In this case, the information processing apparatus 1, for example, puts, into the instruction information, information of a character string “The following 10 users are going to hold a discussion. The agenda, termination conditions of the discussion, and detailed information of the 10 users are as follows”, agenda information, termination condition information, information indicating a plurality of personas, output instruction information, and the like.

The information processing apparatus 1 can also input, for example, information to the generative AI as the input information, the information further including the constraint condition information in the instruction information, the constraint condition information being included in the discussion information request. The constraint condition information is information indicating constraint conditions for discussions by a plurality of personas, and is information indicating requests for discussion content by the user M.

In this case, the information processing apparatus 1, for example, puts, into the instruction information, information of a character string “The following 10 users are going to hold a discussion. The agenda, termination conditions of the discussion, and detailed information of the 10 users are as follows”, agenda information, termination condition information, information indicating a plurality of personas, output instruction information, and the like.

The information processing apparatus 1 can also input information to the generative AI as the input information, the information further including information instructing a facilitator to proceed with a discussion in the instruction information, the facilitator summarizing opinions expressed by the personas.

In this case, the information processing apparatus 1 puts, for example, role information that is information indicating the role of the facilitator into the instruction information. The role information includes, for example, information of a character string “#Facilitator ¥nfacilitator facilitating the discussion. The facilitator needs to ask 10 users to talk. Once the facilitator has heard all the users' ideas and the discussion has come to a conclusion, the facilitator needs to facilitate the discussion and ask the users to talk again to delve into specific details”, and the like, but is not limited to such an example.

When instructing the facilitator to proceed with the discussion, the information processing apparatus 1 puts information instructing the facilitator to speak first into the instruction information. This allows the information processing apparatus 1 to cause the generative AI to appropriately generate information indicating discussions by the personas.

The above-mentioned generative AI is placed in an external information processing apparatus, and the information processing apparatus 1 acquires information indicating a discussion by causing the generative AI to generate the information via an application programming interface (API) provided by the external information processing apparatus; however, the present invention is not limited to such an example. For example, the generative AI may be placed within the information processing apparatus 1.

Subsequently, the information processing apparatus 1 provides the discussion information to the user M by transmitting the discussion information to the terminal device 3 of the user M (step S5). The user M is an example of a target person to whom the discussion information is provided.

For example, the information processing apparatus 1 can provide the discussion information to the user M each time a persona makes an utterance or a facilitator makes an utterance. This allows the user M to ascertain the progress of the discussion in real time.

By operating the terminal device 3, the user M can input questions related a discussion to the terminal device 3. When the questions related a discussion are received from the user M, the terminal device 3 transmits question information that is information indicating the questions related a discussion to the information processing apparatus 1.

The information processing apparatus 1 receives the question information transmitted from the terminal device 3 (step S6). When the question information is received, the information processing apparatus 1 inputs information further including the question information in the instruction information to the generative AI as the input information.

For example, it is assumed that the agenda is “Housing that the child-rearing generation wants to live in (custom-built houses, detached houses for sale, condominiums, and the like)”. The user M can see a persona discussion, and for example, input, as question information, information of a character string “Human: In listening to your opinions, I recognized that the surrounding environment is more important than the layout and functions of the house. Is there any error in this recognition?”.

In this case, the information processing apparatus 1 generates instruction information in which the information of the character string “Human: In listening to your opinions, I recognized that the surrounding environment is more important than the layout and functions of the house. Is there any error in this recognition?” is included in the persona's past utterance history. This allows the information processing apparatus 1 to involve the user M in the discussion, and allows the discussion by the personas to proceed more appropriately.

By operating the terminal device 3, the user M can also input additional persona information to the terminal device 3, the additional persona information that is information indicating additional personas that are personas other than the personas. When the additional persona information is received from the user M, the terminal device 3 transmits question information being the additional persona information to the information processing apparatus 1. The additional persona information includes, for example, attribute information of the additional persona and topic information corresponding to the additional persona.

The information processing apparatus 1 receives the additional persona information transmitted from the terminal device 3 (step S7). When the additional persona information is received, the information processing apparatus 1 inputs information including the persona information in the instruction information to the generative AI as the input information, the persona information including the additional persona information added thereto.

This allows the information processing apparatus 1 to input information to the generative AI as the input information, the information including, as the instruction information, information instructing the discussion by the additional persona indicated by the additional persona information and the personas described above.

When the discussion is completed, the information processing apparatus 1 creates a mind map of the discussions on the agenda on the basis of the information indicating the discussions on the specific agenda by the personas (step S8).

The information processing apparatus 1 inputs, for example, information of a character string “Input the exchange of a certain discussion. Please summarize the exchange into a mind map. The output needs to be text data in a format corresponding to the syntax of mermaid.js.” and information including the discussion information to the generative AI as the input information, and causes the generative AI to output data used to create the mind map.

Subsequently, the information processing apparatus 1 creates a mind map on the basis of the text data output from the generative AI. When the generative AI is a multimodal AI or an image generative AI, the information processing apparatus 1 can also cause the generative AI to directly create the mind map. The image generative AI is, for example, StackGAN (generative adversarial networks), AttnGAN, T2I (text-to-image) with transformers, DALL-E, or the like, but is not limited to such examples.

Thus, the information processing apparatus 1 determines a plurality of personas different from each other by clustering based on user information that is information of each user U who has performed a specific behavior in an online service, and causes the generative AI to generate information indicating a discussion on a specific agenda by the personas on the basis of information indicating the personas. This allows the information processing apparatus 1 to obtain more appropriate discussions on the agenda.

The following is a detailed description of the configuration and the like of an information processing system including the information processing apparatus 1, terminal devices 2, the terminal device 3, and the information processing apparatus 4 that perform such processes.

### 2. Configuration of Information Processing System

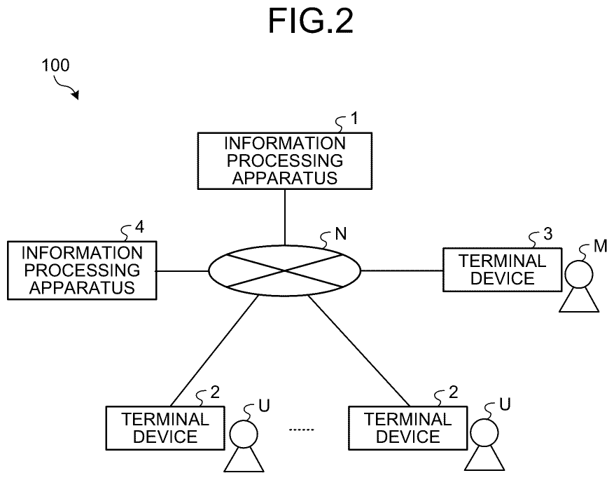

FIG. 2 is a diagram illustrating an example of the configuration of an information processing system according to an embodiment. As illustrated in FIG. 2, an information processing system 100 according to an embodiment includes the information processing apparatus 1, the terminal devices 2, the terminal device 3, and the information processing apparatus 4.

The terminal devices 2 are used by the users U different from each other. The terminal device 3 is, for example, a terminal device of the user M such as an employee of a company or an employee of a municipality. The terminal devices 2 and 3 are, for example, notebook personal computers (PCs), desktop PCs, smartphones, tablet PCs, and wearable devices. The wearable device is, for example, a smart glass, a smart watch, or the like, but is not limited to such examples.

The information processing apparatus 4 provides various online services to the user U. For example, the information processing apparatus 4 provides the online Q&A service, the online search service, the online news providing service, the online bulletin board service, and the like to the user U, but is not limited to such examples.

Each of the information processing apparatus 1, the terminal device 2, the terminal device 3, and the information processing apparatus 4 is connected via a network N to be able to communicate with one another in a wired or wireless manner. The information processing system 100 illustrated in FIG. 2 may include a plurality of the information processing apparatuses 1 and the like.

The network N includes, for example, a wide area network (WAN) such as the Internet and a mobile communication network such as Long Term Evolution (LTE), 4G (4th generation), and 5G (5th generation: 5th mobile communication system).

The terminal devices 2 and 3 can be connected to the network N via short-range wireless communication such as a mobile communication network, Bluetooth (registered trademark), and a wireless local area network (LAN), and can communicate with the information processing apparatus 1, the information processing apparatus 4, and the like.

### 3. Configuration of Information Processing Apparatus 1

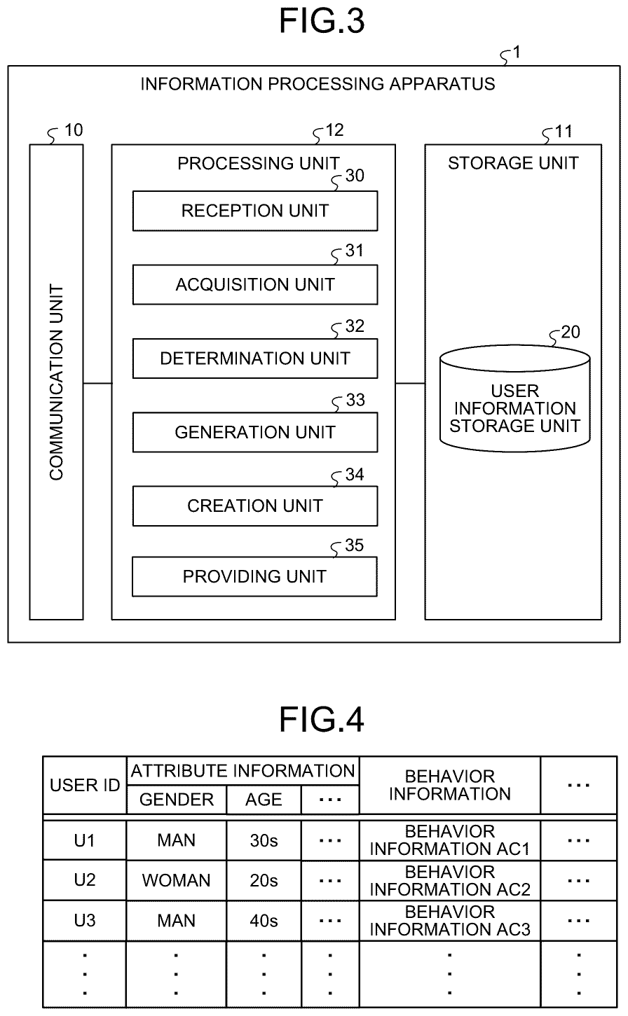

FIG. 3 is a diagram illustrating an example of the configuration of the information processing apparatus 1 according to an embodiment. As illustrated in FIG. 3, the information processing apparatus 1 has a communication unit 10, a storage unit 11, and a processing unit 12.

### 3.1. Communication Unit 10

The communication unit 10 is implemented with, for example, a communication module or a network interface card (NIC). The communication unit 10 is connected to the network N in a wired or wireless manner, and transmits and receives information to and from various other devices. For example, the communication unit 10 transmits and receives information via the network N to and from each of the terminal device 2, the terminal device 3, and the information processing apparatus 4.

### 3.2. Storage Unit 11

The storage unit 11 is implemented with, for example, a semiconductor memory element such as a random access memory (RAM) or a flash memory, or a storage device such as a hard disk or an optical disc. The storage unit 11 has a user information storage unit 20.

### 3.2.1. User Information Storage Unit 20

The user information storage unit 20 stores the user information including the information on the user U. FIG. 4 is a diagram illustrating an example of a user information table stored in the user information storage unit 20 of the information processing apparatus 1 according to an embodiment. As illustrated in FIG. 4, the user information table stored in the user information storage unit 20 includes items such as “user ID”, “attribute information”, and “behavior history”.

The “user ID” is identification information for identifying the user U. The “attribute Information” is attribute information of the user U corresponding to the “user ID”, and includes, for example, information of psychographic attributes, information of demographic attributes, and the like. The demographic attributes are, for example, gender, age, place of residence, occupation, and the like, and the psychographic attributes are interests such as travel, clothing, cars, and religion, lifestyle, thoughts, ideological tendencies, and the like.

The “behavior history” is the behavior history of the user U in online services, and includes, for example, information of search history, browsing history, posting history, purchase history, and the like. The search history is information of search queries used by the user U in past searches, content viewed by the user U among search results, and the like. The information of search queries is, for example, information on search keywords or search phrases.

The browsing history includes, for example, information indicating content viewed by the user U in the online services, and the posting history includes, for example, information indicating content (for example, reviews, comments, and the like) posted by the user U in the past in the online services. The purchase history includes information of transaction targets with which the user U has transacted in the past.

### 3.3. Processing Unit 12

The processing unit 12 is a controller, and is implemented with a processor such as a central processing unit (CPU) or a micro processing unit (MPU) executing various computer programs (equivalent to an example of an information processing program) stored in a storage device inside the information processing apparatus 1 by using a RAM or the like as a working area.

The processing unit 12 is a controller, and may be implemented with an integrated circuit such as an application specific integrated circuit (ASIC), a field programmable gate array (FPGA), or a general purpose graphic processing unit (GPGPU).

As illustrated in FIG. 3, the processing unit 12 has a reception unit 30, an acquisition unit 31, a determination unit 32, a generation unit 33, a creation unit 34, and a providing unit 35, and implements or performs the functions and actions of information processing to be described below. The internal configuration of the processing unit 12 is not limited to the configuration illustrated in FIG. 3, but may be any other configuration as long as it is configured to perform the information processing to be described below.

### 3.3.1. Reception Unit 30

The reception unit 30 receives various requests and information via the network N and the communication unit 10. For example, the reception unit 30 receives the discussion information requests transmitted from the terminal device 3. The discussion information request includes, for example, information to be acquired, agenda information, termination condition information, constraint condition information, and the like.

The information to be acquired is information that designates information used to determine a persona, and includes, for example, type information indicating the type of online service designated by the user M and target behavior-specific information specifying a target behavior being a behavior designated by the user M in the online service. The target behavior is an example of a specific behavior.

Types of online games include online question and answer (Q&A) services, online search services, online news providing services, online bulletin board services, and the like, which are online services provided by the information processing apparatus 4, but are not limited to such examples.

The target behavior is, for example, the use of a service in a specific category for services such as the online Q&A services, the online bulletin board services, and the online news providing services, or a search using a specific search query for online search services, but is not limited to such examples.

The use of the service in the specific category, for example, is the viewing of information (for example, information indicating a question or information indicating an answer) in the specific category in the case of the online Q&A services, but is not limited to such examples. For example, the use of the service in the specific category may be the posting of the information (for example, information indicating a question or information indicating an answer) in the specific category instead of the viewing of the information in the specific category.

The search using the specific search query is, for example, a search in the online search service using a search query including a specific search keyword, a specific phrase, or the like, but is not limited to such examples. For example, the search using the specific search query may be a search in the online Q&A service or the like using the search query including the specific search keyword, the specific phrase, or the like.

The target behavior-specific information is information indicating specific terms related to the online Q&A service, for example, information indicating one or more specific terms included in one or more categories. In this case, the use of a service of a category including the specific terms is the target behavior. In the online Q&A service, categories are represented in a hierarchical structure.

For example, the category “childbirth” is represented by a top layer “parenting and school”, a middle layer “parenting”, a bottom layer “childbirth”, and the like, but is not limited to such examples and may be represented by four or more layers or two or less layers.

For example, in the case of a category related to parenting, the specific terms include “elementary school”, “pregnancy”, “childbirth”, “early childhood education”, “kindergarten”, “daycare center”, “entrance exam”, “child”, “children”, “high school”, “home”, and the like, but are not limited to such examples.

The target behavior-specific information may be, for example, category name information, and is, for example, information of categories shown in a hierarchical structure, such as information of a character string “Parenting and school>parenting>childbirth”, but is not limited to such examples. For example, information specifying a category indicated by the target behavior-specific information may be information of the category indicated by the top layer, the middle layer, or the bottom layer.

The target behavior-specific information is, for example, information specifying a specific search query in a search service, and includes, for example, information of a specific search keyword, a specific search phrase, or the like. In this case, the target behavior is a search with a search query including the specific search keyword or the specific search phrase in whole or in part.

The agenda information is information indicating a specific agenda designated by the user M. The termination condition information is information indicating termination conditions for discussions on a specific agenda. The constraint condition information is information indicating constraint conditions for discussions by a plurality of personas to be determined by the determination unit 32.

For example, it is assumed that the user M is an employee of a travel agency. In this case, the agenda is, for example, “Travel Policies for Child-rearing Generation”. The termination condition is, for example, to “summarize one specific travel policy for the child-rearing generation based on everyone's opinions”. The constraint condition is, for example, “most of the child-rearing generation stays one night on trips, so we would like to implement measures to extend one night to two nights or more. We would like you to consider measures based on the concerns and needs of the child-rearing generation when traveling”.

In addition, it is assumed that the user M is an employee of a developer. In this case, the agenda is, for example, “Housing that the child-rearing generation wants to live in (custom-built houses, detached houses for sale, condominiums, and the like)”. The termination condition is, for example, “based on everyone's opinions, please determine three child-rearing support measures that would make the city a more desirable place to raise children”. The constraint condition is, for example, “we would like to know what measures the child-rearing generation requires to overcome the declining birthrate and aging population”.

In addition, it is assumed that the user M is an employee of a municipality. In this case, the agenda is, for example, “Child-rearing Support Measures”. The termination condition is, for example, “summarize three conditions for housing that the child-rearing generation wants to live in”. The constraint condition is, for example, “as a developer, I want to ascertain housing required by the child-rearing generation”.

The reception unit 30 also receives the question information transmitted from the terminal device 3. By operating the terminal device 3, the user M inputs questions related a discussion to the terminal device 3. When the questions related a discussion are received from the user M, the terminal device 3 transmits question information that is information indicating the questions related a discussion to the information processing apparatus 1.

The reception unit 30 also receives the additional persona information transmitted from the terminal device 3. The additional persona information includes, for example, attribute information of the additional persona and topic information corresponding to the additional persona.

By operating the terminal device 3, the user M can input additional persona information to the terminal device 3, the additional persona information that is information indicating additional personas that are personas other than the personas. When the additional persona information is received from the user M, the terminal device 3 transmits question information being the additional persona information to the information processing apparatus 1.

### 3.3.2. Acquisition Unit 31

The acquisition unit 31 acquires various types of information via the network N and the communication unit 10. For example, the acquisition unit 31 acquires various types of information from the terminal device 2, the terminal device 3, the information processing apparatus 4, and the like.

The acquisition unit 31 acquires the user information that is information of each user U who has performed a specific behavior in the online service from the information processing apparatus 4, the storage unit 11, or the like. For example, when the discussion information request is received by the reception unit 30, the acquisition unit 31 acquires the user information, which is information of each user U who has performed the target behavior specified by the information to be acquired for the type of online service specified by the information to be acquired included in the discussion information request, from the information processing apparatus 4, the storage unit 11, or the like.

The user information includes the attribute information and the behavior information of the user U. The attribute information of the user U is, for example, information indicating the attributes of the user U. The attributes of the user U are, for example, the demographic attributes of the user U, but may also be the psychographic attributes of the user U or a combination of the demographic attributes and the psychographic attributes of the user U.

The behavior information of the user U is information on the target behavior by the user U who performed the target behavior specified by the information to be acquired. The target behavior is an example of a specific behavior. For example, when the type of online service specified by the information to be acquired is the online Q&A service, the behavior information of the user U is information indicating the usage content of a service in a specific category being a category specified by the target behavior-specific information.

The usage content of the specific category is, for example, viewing of information (for example, information indicating a question or information indicating an answer) of the specific category, posting of information (for example, information indicating a question or information indicating an answer) to the specific category, and the like, but is not limited to such examples.

When the type of online service specified by the information to be acquired is the online search service, the behavior information of the user U is information indicating the content viewed by performing a search with a search query including a specific search keyword or a specific phrase indicated by the target behavior-specific information, or the like, but is not limited to such examples.

For example, the behavior information of the user U may be the past content browsing history of the user U who has performed the search with the search query including the specific search keyword or the specific phrase indicated by the target behavior-specific information.

### 3.3.3. Determination Unit 32

The determination unit 32 makes various determinations. For example, the determination unit 32 determines a plurality of personas different from each other by clustering based on the user information acquired by the acquisition unit 31.

For example, it is assumed that the type of online service indicated by the type information of the information to be acquired included in the discussion information request is the online Q&A service and a specific behavior indicated by target specific information of the information to be acquired included in the discussion information request is a category including specific terms.

In this case, for example, the determination unit 32 extracts a plurality of words from information of a specific category being the category including the specific terms, and clusters the users U by dividing each specific category into topics from the words by using the LDA.

For example, the determination unit 32 extracts a plurality of feature words for each specific category from the information of the specific category being the category including the specific term indicated by the target behavior-specific information. The determination unit 32, for example, extracts individual words included in the information of the specific category and removes meaningless words from the extracted words.

The determination unit 32 acquires feature words as vectors from the words from which the meaningless words have been removed, by using the TF-IDF, the Bag-of-Words, or the like. The determination unit 32 uses the LDA to determine topics of each specific category from the feature words extracted as the vectors, and performs topic classification for classifying each specific category into a corresponding topic. The determination unit 32 clusters the users U by classifying the users U who have used the specific category into topics corresponding to the specific category.

The information of the specific category is information indicating the name of the specific category, but is not limited to such an example. For example, the information of the specific category may include information posted in the specific category (for example, information indicating a question, information indicating an answer, or the like) instead of or in addition to the information indicating the name of the specific category.

In addition, it is assumed that the type of online service indicated by the type information of the information to be acquired included in the discussion information request is the online search service and the specific behavior indicated by the target specific information of the information to be acquired included in the discussion information request is a search with a specific search query.

In this case, for example, the determination unit 32 extracts a plurality of words from the content viewed by performing a search with a search query including specific search keywords or specific phrases indicated by the target behavior-specific information, and clusters the user U by dividing each specific category into topics by using the LDA from the words.

For example, the determination unit 32 can also extract a plurality of words from the content viewed in the past by the user U who performed a search with a search query including a specific search keyword or a specific phrase indicated by the target behavior-specific information, and cluster the user U by dividing each specific category into topics by using the LDA from the words.

The clustering performed by the determination unit 32 is not limited to the examples described above. For example, the determination unit 32 can cluster the users U by using k-means clustering, hierarchical clustering, density-based spatial clustering of applications with noise (DBSCAN), or the like, cluster the users U by using learned models such as naive Bayes classifiers, support vector machines, neural networks, or generative AI, or cluster the users U on a rule basis such as using a dictionary for each topic.

For example, the determination unit 32 inputs information of a specific category for each specific category to the learned model and causes the learned model to perform topic classification of the specific category. Subsequently, the determination unit 32 clusters the users U by classifying the users U who have used the specific category into topics corresponding to the specific category.

The determination unit 32 classifies users U, who have used a specific category classified into each of a plurality of topics different from each other, into each of the topics, but can also classify the users U into a topic with the highest number of uses of the specific category, for example.

On the basis of the percentage of the users U classified into each topic, the determination unit 32 extracts, as a target topic, a topic for which the percentage of the users U is equal to or greater than a threshold value, and determines a persona corresponding to such a target topic. The threshold value is 5%, but is not limited to such an example.

For example, on the basis of the attribute information of the user U classified into the target topic and target topic information that is information on the target topic, the determination unit 32 determines a persona corresponding to the target topic.

For example, the determination unit 32 determines, as persona information corresponding to the target topic, information including attributes having a high percentage among the attributes of the user U classified into the target topic and the information of the specific category classified into the target topic. Attributes, whose information are included in the persona information, are indicated, for example, by gender and age, but are not limited to such examples and may be indicated, for example, by family structure, annual income, place of residence, occupation, and the like, in addition to or instead of gender and age.

For example, the determination unit 32 rounds off the first place of the percentage of users U belonging to a topic whose percentage of users U is equal to or greater than the threshold value, and then uses a value obtained by dividing the resultant value by 10 as the number of personas corresponding to the topic; however, the present invention is not limited to such an example.

When the number of personas corresponding to the same target topic is one, the determination unit 32 sets, as the attribute of the persona, the attribute with the highest percentage among the attributes of the user U classified into the target topic. When the number of personas corresponding to the same target topic is two or more, the determination unit 32 sets each of two or more attributes as the attribute of a corresponding persona out of the two or more personas in the order of the attributes with the highest percentage among the attributes of the user U classified into the target topic.

The target topic information included in the persona information is information indicating the target topic, but may also be information obtained by summarizing the information of the specific category classified into the target topic, by text generative AI.

The text generative AI is, for example, a language model trained to infer a next token from an input token sequence and output the inferred token, such as transfer-based models or RNN-based models.

The transfer-based models are, for example, GPT, BARD, and the like, but are not limited to such examples. The RNN-based models are, for example, RWKV and the like, but are not limited to such examples. Note that input information is desirably kept confidential, such as personal information, by learning not to use the input information as a new answer.

For example, it is assumed that topics to be classified by the user U are first to tenth topics and the target topics are the second topic, the fourth topic, the fifth topic, and the seventh to tenth topics. In addition, it is assumed that the number of personas corresponding to the fourth topic, the ninth topic, and the tenth topic is two.

In this case, the determination unit 32 determines 10 personas, for example, a woman in her 30s with the second topic in the background, a woman in her 20s with the fourth topic in the background, a woman in her 30s with the fourth topic in the background, a woman in her 20s with the fifth topic in the background, a woman in her 30s with the seventh topic in the background, a woman in her 30s with the eighth topic in the background, a woman in her 30s with the ninth topic in the background, a woman in her 40s with the ninth topic in the background, a woman in her 20s with the tenth topic in the background, and a woman in her 30s with the tenth topic in the background.

### 3.3.4. Generation Unit 33

The generation unit 33 generates various types of information. For example, the generation unit 33 causes the generative AI to generate information indicating discussions on a specific agenda by the personas on the basis of information indicating the personas determined by the determination unit 32. The generative AI is the text generative AI described above or the multimodal AI described above.

For example, the generation unit 33 inputs, to the generative AI as the input information, information including instruction information that directs the discussions on a specific agenda by the personas determined by the determination unit 32, and causes the generative AI to generate information indicating the discussions by the personas.

The specific agenda is an agenda indicated by the agenda information included in the discussion information request, but is not limited to such an example. For example, the generation unit 33 can input information including an instruction of generating an agenda to the generative AI as the input information, and cause the generative AI to generate agenda information.

The instruction information includes, for example, agenda information indicating a specific agenda, persona information including information on each of a plurality of personas, a persona's past utterance history, output instruction information that instructs the selection of a persona to speak from the personas indicated by the persona information and the output of an utterance to a previously selected persona, and the like.

By inputting the information including the instruction information to the generative AI as the input information, the generation unit 33 repeats a process of causing the generative AI to output output information including information indicating a persona selected as a next speaker and information indicating an utterance of a persona selected as a current speaker. This allows the generation unit 33 to cause the generative AI to generate discussion information that is information indicating discussions by a plurality of personas. When a predetermined number of repetitions is reached, the generation unit 33 terminates the generation of the discussion information by the generative AI.

When the generative AI is GPT-4 provided by OpenAI, the agenda information indicating a specific agenda, the persona information including information on each of the personas, the output instruction information, and the like are set as system message information, while the information indicating a selected persona and the persona's past utterance history are set as user prompts, but are not limited to such examples.

The instruction information includes, for example, information of a character string “The following 10 users are going to hold a discussion. The agenda and detailed information of the 10 users are as follows”, and the like, which allows the generative AI to appropriately generate the information indicating discussions by the personas. Detailed information of the users is persona information and includes topic information, attribute information, and the like as described above. The persona information may include, for example, information of a category frequently used by the user U instead of the topic information.

The generation unit 33 can also input information to the generative AI as the input information, the information further including the termination condition information in the instruction information, the termination condition information being included in the discussion information request. The termination condition information is information indicating termination conditions for discussions on a specific agenda.

In this case, the generation unit 33, for example, puts, into the instruction information, information of a character string “The following 10 users are going to hold a discussion. The agenda, termination conditions of the discussion, and detailed information of the 10 users are as follows”, agenda information, termination condition information, information indicating a plurality of personas, output instruction information, and the like.

The generation unit 33 can also input, for example, information to the generative AI as the input information, the information further including the constraint condition information in the instruction information, the constraint condition information being included in the discussion information request. The constraint condition information is information indicating constraint conditions for discussions by a plurality of personas, and is information indicating requests for discussion content by the user M.

In this case, the generation unit 33, for example, puts, into the instruction information, information of a character string “The following 10 users are going to hold a discussion. The agenda, termination conditions of the discussion, and detailed information of the 10 users are as follows”, agenda information, termination condition information, information indicating a plurality of personas, output instruction information, and the like.

The generation unit 33 can also input information to the generative AI as the input information, the information further including information instructing a facilitator to proceed with a discussion in the instruction information, the facilitator summarizing opinions expressed by the personas.

In this case, the generation unit 33 puts, for example, role information that is information indicating the role of the facilitator into the instruction information. The role information includes, for example, information of a character string “#Facilitator ¥nfacilitator facilitating the discussion. The facilitator needs to ask 10 users to talk. Once the facilitator has heard all the users' ideas and the discussion has come to a conclusion, the facilitator needs to facilitate the discussion and ask the users to talk again to delve into specific details”, and the like, but is not limited to such an example.

When instructing the facilitator to proceed with the discussion, the generation unit 33 puts information instructing the facilitator to speak first into the instruction information. This allows the generation unit 33 to cause the generative AI to appropriately generate information indicating discussions by the personas.

When the question information is received by the reception unit 30, the generation unit 33 inputs information further including the question information in the instruction information to the generative AI as the input information. For example, it is assumed that the agenda is “Housing that the child-rearing generation wants to live in (custom-built houses, detached houses for sale, condominiums, and the like)”.

In this case, the user M can see a persona discussion, and cause, for example, information of a character string “Human: In listening to your opinions, I recognized that the surrounding environment is more important than the layout and functions of the house. Is there any error in this recognition?” to be transmitted from the terminal device 3 to the information processing apparatus 1 as question information.

In this case, the generation unit 33 generates instruction information in which the information of the character string “Human: In listening to your opinions, I recognized that the surrounding environment is more important than the layout and functions of the house. Is there any error in this recognition?” is included in the persona's past utterance history. This allows the generation unit 33 to involve the user M in the discussion, and allows the discussion by the personas to proceed more appropriately.

When the additional persona information is received by the reception unit 30, the generation unit 33 inputs information including the persona information in the instruction information to the generative AI as the input information, the persona information including the additional persona information added thereto. The additional persona information includes, for example, attribute information of the additional persona and topic information corresponding to the additional persona.

This allows the generation unit 33 to input information to the generative AI as the input information, the information including, as the instruction information, information instructing the discussion by the additional persona indicated by the additional persona information and the personas described above.

The above-mentioned generative AI is placed in an external information processing apparatus, and the generation unit 33 acquires information indicating a discussion by causing the generative AI to generate the information via an API provided by the external information processing apparatus; however, the present invention is not limited to such an example. For example, the generative AI may be placed within the information processing apparatus 1.

### 3.3.5. Creation Unit 34

The creation unit 34 creates a mind map of the discussions on the agenda on the basis of the information indicating the discussions on the specific agenda by the personas.

The creation unit 34 inputs, for example, information of a character string “Input the exchange of a certain discussion. Please summarize the exchange into a mind map. The output needs to be text data in a format corresponding to the syntax of mermaid.js.” and information including the discussion information to the generative AI as the input information, and causes the generative AI to output data used to generate the mind map.

Subsequently, the creation unit 34 creates a mind map on the basis of the text data output from the generative AI. When the generative AI is a multimodal AI or an image generative AI, the creation unit 34 can also cause the generative AI to directly create a mind map. The image generative AI is, StackGAN, AttnGAN, T2I with transformers, DALL-E, or the like, but is not limited to such examples.

### 3.3.6. Providing Unit 35

The providing unit 35 provides various types of information to the user M. For example, the providing unit 35 provides the discussion information generated by the generation unit 33 to the user M by transmitting the discussion information generated by the generation unit 33 to the terminal device 3 of the user M. The discussion information generated by the generation unit 33 is an example of information indicating a discussion on a specific agenda by a persona, and the user M is an example of a target person.

For example, the providing unit 35 can provide the discussion information to the user M each time a persona makes an utterance or a facilitator makes an utterance. This allows the user M to ascertain the progress of the discussion in real time.

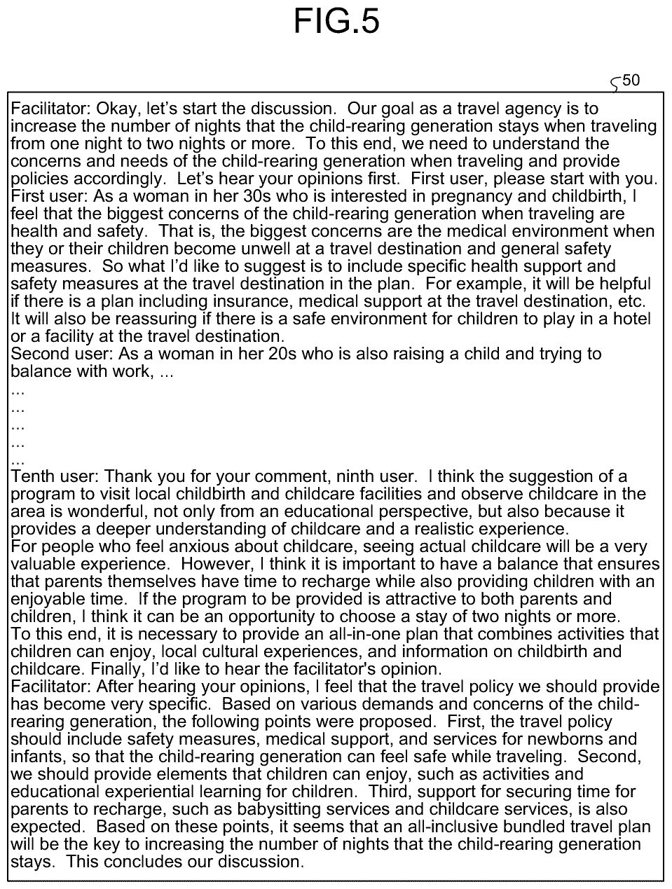

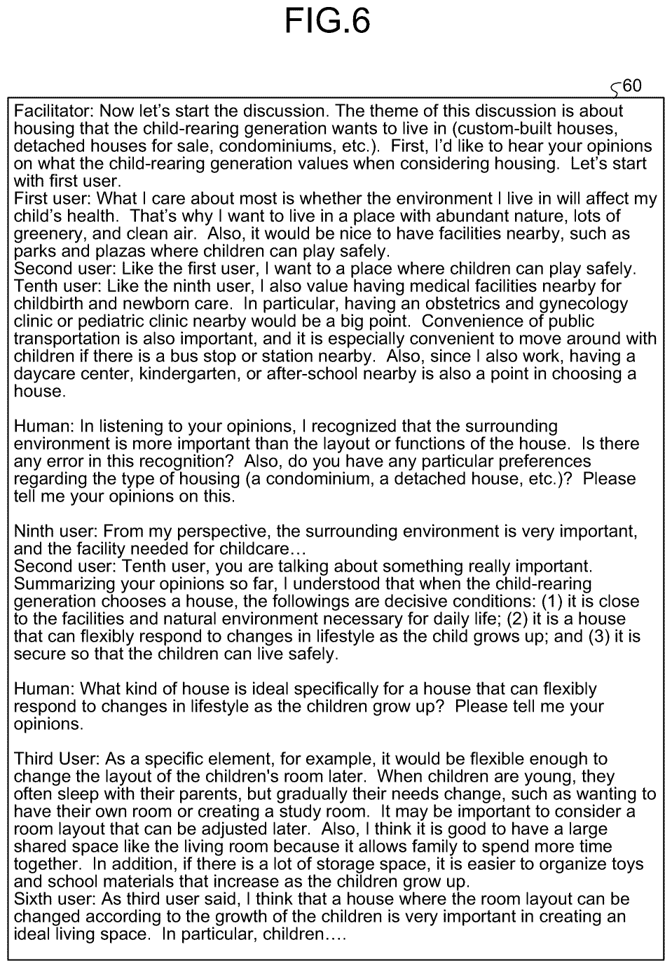

FIG. 5 is a diagram illustrating an example of the discussion information provided to the user M by the providing unit 35 in the processing unit 12 of the information processing apparatus 1 according to an embodiment. FIG. 6 is a diagram illustrating another example of the discussion information provided to the user M by the providing unit 35 in the processing unit 12 of the information processing apparatus 1 according to an embodiment.

Discussion information 50 illustrated in FIG. 5 indicates, for example, discussion information when the user M is an employee of a travel agency, the agenda is “Travel Policies for Child-rearing Generation”, the termination condition is to “summarize one specific travel policy for child-rearing generation based on everyone's opinions”, and the constraint condition is “most of the child-rearing generation stays one night on trips, so we would like to implement measures to extend one night to two nights or more. We would like you to consider measures based on the concerns and needs of the child-rearing generation when traveling”. In the discussion information 50, the facilitator is acting as a discussion facilitator and the discussion is ongoing.

Discussion information 60 illustrated in FIG. 6 indicates discussion information when the user M is an employee of a municipality, the agenda is “Child-rearing Support Measures”, the termination condition is “summarize three conditions for housing that the child-rearing generation wants to live in”, and the constraint condition is “as a developer, I want to ascertain housing required by the child-rearing generation”.

In the discussion information 60, the facilitator is facilitating the discussion as a discussion facilitator, and the discussion progresses as the user M asks a question “In listening to your opinions, I recognized that the surrounding environment is more important than the layout and functions of the house. Is there any error in this recognition? Also, are you less particular about the type of residence (condominium, detached house, or the like)? What are your opinions on these matters?” and a question “What kind of house is ideal specially for a house that can flexibly respond to changes in lifestyle as the children grow up? Please tell me your opinions”.

The providing unit 35 provides the information of the mind map created by the creation unit 34 to the user M by transmitting the information of the mind map created by the creation unit 34 to the terminal device 3 of the user M.

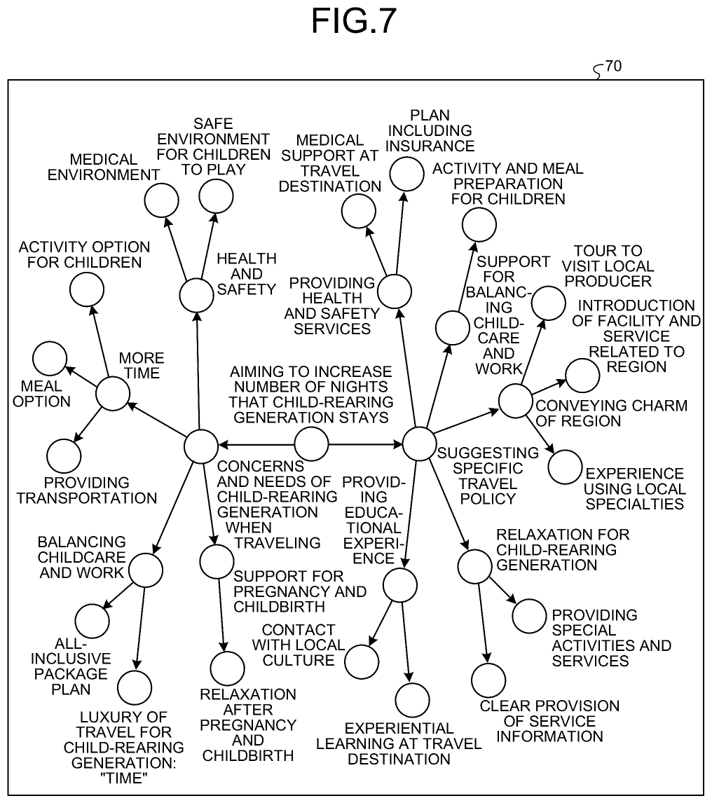

FIG. 7 is a diagram illustrating an example of mind map information provided to the user M by the providing unit 35 in the processing unit 12 of the information processing apparatus 1 according to an embodiment. A mind map 70 illustrated in FIG. 7 is generated by the creation unit 34 on the basis of the discussion indicated by the discussion information illustrated in FIG. 5.

### 4. Processing Procedure

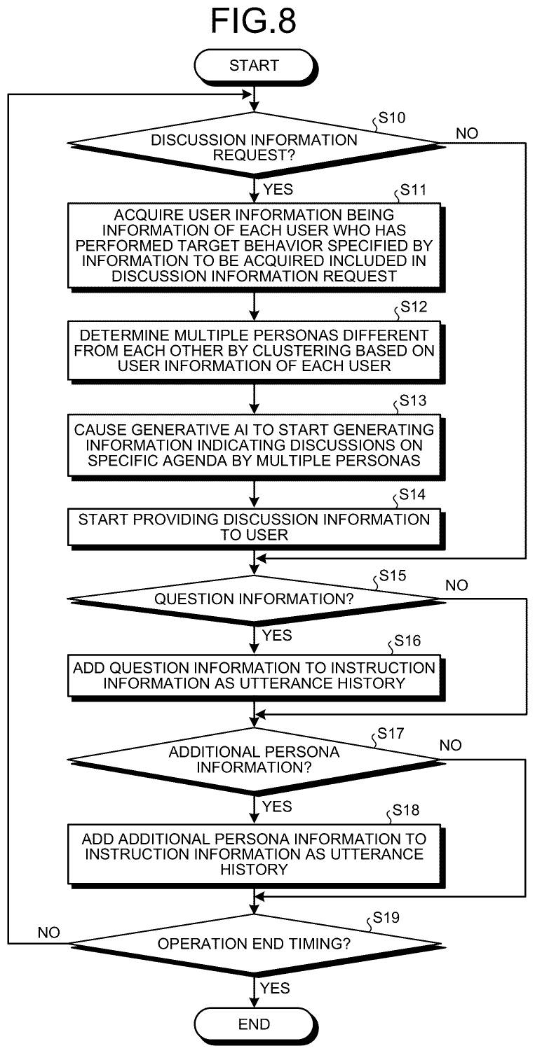

An information processing procedure performed by the processing unit 12 of the information processing apparatus 1 according to an embodiment is described below. FIG. 8 is a flowchart showing an example of information processing performed by the processing unit 12 of the information processing apparatus 1 according to an embodiment.

As illustrated in FIG. 8, the processing unit 12 of the information processing apparatus 1 determines whether a discussion information request has been received (step S10). When it is determined that the discussion information request has been received (Yes at step S10), the processing unit 12 acquires user information that is information of each user U who has performed a target behavior specified by information to be acquired included in the discussion information request (step S11).

Subsequently, the processing unit 12 determines a plurality of personas different from each other by clustering based on the user information of each user U acquired at step S11 (step S12). Subsequently, the processing unit 12 causes the generative AI to start generating information indicating discussions on a specific agenda by the personas determined at step S12 (step S13), and start providing the discussion information to the user M (step S14).

When the process of step S14 is completed or when it is determined that no discussion information request has been received (No at step S10), the processing unit 12 determines whether question information has been received (step S15). When it is determined that the question information has been received (Yes at step S15), the processing unit 12 adds the question information to instruction information as an utterance history (step S16).

When the process of step S16 is completed or when it is determined that no question information has been received (No at step S15), the processing unit 12 determines whether additional persona information has been received (step S17). When it is determined that the additional persona information has been received (Yes at step S17), the processing unit 12 adds the additional persona information to the instruction information as an utterance history (step S18).

When the process at step S17 is completed or when it is determined that no additional persona information has been received (No at step S17), the processing unit 12 determines whether an operation end timing has been reached (step S19). The processing unit 12 determines that the operation end timing has been reached, for example, when the information processing apparatus 1 is powered off.

When it is determined that no operation end timing has been reached (No at step S19), the processing unit 12 shifts the procedure to step S10, and when it determines that the operation end timing has been reached (Yes at step S19), the processing unit 12 terminates the procedure illustrated in FIG. 8.

### 5. Modification

In the example described above, when the discussion information request is received by the reception unit 30, the user information of each user U is acquired by the acquisition unit 31, a plurality of personas are determined by the determination unit 32, and discussion information is generated by the generation unit 33; however, the present invention is not limited to such an example.

For example, after the discussion information request is received by the reception unit 30, when predetermined conditions are satisfied, the user information of each user U may be acquired by the acquisition unit 31, the personas may be determined by the determination unit 32, and the discussion information may be generated by the generation unit 33.

The predetermined conditions may be, for example, a condition that the number of users U who have performed the target behavior indicated in the discussion information request is equal to or greater than a predetermined number, a condition that the number of users U who have performed the target behavior indicated in the discussion information request per unit time is equal to or greater than the predetermined number, and the like.

The generation unit 33 can also exclude some personas from the personas to be participated in a discussion. For example, when exclusion information that is information indicating a persona to be excluded by the user M of the terminal device 3 is received by the reception unit 30, the generation unit 33 can exclude information of the persona indicated by the exclusion information from instruction information and cause the generative AI to generate discussion information by using the instruction information from which the information of the persona indicated by the exclusion information has been excluded.

In the example described above, by inputting information including the instruction information to the generative AI as the input information, the generation unit 33 generates the discussion information by repeating a process of causing the generative AI to output output information including information indicating a persona selected as a next speaker and information indicating an utterance of a persona selected as a current speaker; however, the generation of the discussion information is not limited to such an example.

For example, the generation unit 33 may cause the generative AI to generate the discussion information by inputting, to the generative AI as the input information, instruction information including output instruction information, agenda information, termination condition information, constraint condition information, persona information, and the like, the discussion information instructing a plurality of personas to hold a discussion. In this case, the output instruction information is, for example, information of a character string “The following 10 users are going to hold a discussion. The agenda and detailed information of the 10 users are as follows. Please output the content of the discussion among the 10 users”, but is not limited to such an example. Also in this case, the generation unit 33 can put information that instructs a facilitator to proceed with a discussion, question information, additional persona information, and the like into the instruction information.

### 6. Hardware Configuration

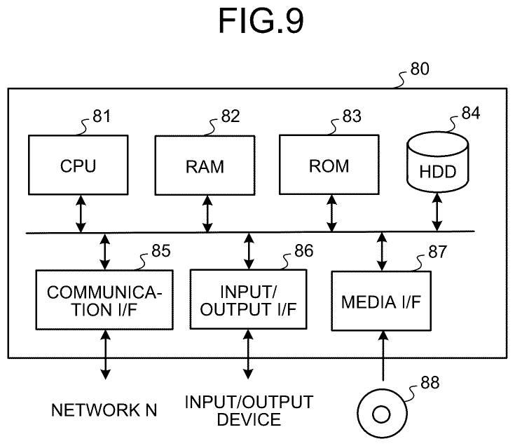

The information processing apparatus 1 according to an embodiment described above is implemented, for example, with a computer 80 having a configuration illustrated in FIG. 9. FIG. 9 is a hardware configuration diagram illustrating an example of the computer 80 that implements the functions of the information processing apparatus 1 according to an embodiment. The computer 80 has a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates on the basis of computer programs stored in the ROM 83 or the HDD 84 and controls each component. The ROM 83 stores a boot program to be executed by the CPU 81 at the startup of the computer 80, computer programs dependent on the hardware of the computer 80, and the like.

The HDD 84 stores the computer programs executed by the CPU 81, data used by such computer programs, and the like. The communication interface 85 receives data from other devices via the network N (see FIG. 2) and transmits the received data to the CPU 81, and transmits data generated by the CPU 81 to the other devices via the network N.

The CPU 81 controls output devices such as displays and printers and input devices such as keyboards or mice via the input/output interface 86. The CPU 81 acquires data from the input devices via the input/output interface 86. The CPU 81 also outputs the generated data to the output devices via the input/output interface 86.

The media interface 87 reads computer programs or data stored on recording media 88 and provides the computer programs to the CPU 81 via the RAM 82. The CPU 81 loads such computer programs onto the RAM 82 from the recording media 88 via the media interface 87 and executes the loaded computer programs. The recording media 88 is, for example, optical recording media such as a digital versatile disc (DVD) and a phase change rewritable disk (PD), magneto-optical recording media such as a magneto-optical disk (MO), tape media, magnetic recording media, a semiconductor memory, and the like.

For example, when the computer 80 serves as the information processing apparatus 1 according to an embodiment, the CPU 81 of the computer 80 implements the functions of the processing unit 12 by executing a computer program loaded on the RAM 82. Data in the storage unit 11 is stored in the HDD 84. The CPU 81 of the computer 80 reads these computer programs from the recording media 88 and executes the read computer programs; however, as another example, these computer programs may be acquired from the other devices via the network N.

### 7. Others

Of the respective processes described in the above embodiments, all or some of the processes described as being automatically performed can be manually performed, or all or some of the processes described as being manually performed can be automatically performed by known methods. Other information including processing procedures, specific names, and various data and parameters illustrated in the above document and drawings can be changed as desired, unless otherwise noted. For example, the various types of information illustrated in each drawing is not limited to the information illustrated.

In addition, each component of each device illustrated in the drawings is a functional concept and does not necessarily have to be physically configured as illustrated in the drawings. That is, the specific form of dispersion and integration of each device is not limited to that illustrated in the drawings, but can be configured by functionally or physically dispersing and integrating all or part thereof in arbitrary units according to various loads, usage conditions, or the like.

For example, the information processing apparatus 1 described above may be implemented with a terminal device and a server computer or with a plurality of server computers, and depending on the function, the configuration can be flexibly changed such as by calling an external platform or the like by using API, network computing, or the like and implementing the external platform.

The above-mentioned embodiments and modifications can be appropriately combined within a range in which processing content is not inconsistent.

### 8. Effects

As described above, the information processing apparatus 1 according to an embodiment has the acquisition unit 31, the determination unit 32, and the generation unit 33. The acquisition unit 31 acquires user information that is information of each user U who has performed a specific behavior in an online service. The determination unit 32 determines a plurality of personas different from each other by clustering based on the user information acquired by the acquisition unit 31. The generation unit 33 causes the generative AI to generate information indicating discussions on a specific agenda by the personas on the basis of information indicating the personas determined by the determination unit 32. This allows the information processing apparatus 1 to obtain more appropriate discussions on the agenda.

The user information also includes information indicating the attributes of the user U and information on a specific behavior by the user U. This allows the information processing apparatus 1 to obtain more appropriate discussions on the agenda.

In addition, the generation unit 33 inputs, to the generative AI as the input information, information including instruction information that directs the discussions on the specific agenda by the personas determined by the determination unit 32, and causes the generative AI to generate information indicating the discussions by the personas. This allows the information processing apparatus 1 to obtain more appropriate discussions on the agenda.

In addition, the generation unit 33 inputs information further including the persona's past utterance history on the specific agenda to the generative AI as the input information. This allows the information processing apparatus 1 to obtain more appropriate discussions on the agenda.

The information processing apparatus 1 further includes the reception unit 30 that receives agenda information that is information indicating an agenda, and the generation unit 33 causes the generative AI to generate information indicating the discussions by the personas with the agenda indicated by the agenda information by the reception unit 30 as the specific agenda. This allows the information processing apparatus 1 to obtain more appropriate discussions on the agenda.

The reception unit 30 receives termination condition information indicating termination conditions for the discussions on the specific agenda, and the generation unit 33 inputs information to the generative AI as the input information, the information further including the termination condition information received by the reception unit 30 in the instruction information. This allows the information processing apparatus 1 to obtain more appropriate discussions on the agenda.

In addition, the reception unit 30 receives constraint condition information indicating constraint conditions for the discussion content by the personas, and the generation unit 33 inputs information to the generative AI as the input information, the information further including the constraint condition information received by the reception unit 30 in the instruction information. This allows the information processing apparatus 1 to obtain more appropriate discussions on the agenda.

The information processing apparatus 1 further includes the providing unit 35 that provides a target person with information indicating the discussions on the specific agenda by the persona, the reception unit 30 receives question information indicating a question by the target person, and the generation unit 33 inputs information to the generative AI as the input information, the information further including the question information received by the reception unit 30 in the instruction information. This allows the information processing apparatus 1 to obtain more appropriate discussions on the agenda.

The reception unit 30 also receives additional persona information indicating additional personas being personas other than the personas, and the generation unit 33 inputs information to the generative AI as the input information, the information including, as the instruction information, information instructing a discussion by the additional persona indicated by the additional persona information received by the reception unit 30 and the personas. This allows the information processing apparatus 1 to obtain more appropriate discussions on the agenda.

In addition, the generation unit 33 inputs information to the generative AI as the input information, the information further including information instructing a facilitator to proceed with a discussion in the instruction information, the facilitator facilitating the discussions by the personas. This allows the information processing apparatus 1 to obtain more appropriate discussions on the agenda.

The information processing apparatus 1 further includes the creation unit 34 that creates the mind map 70 of the discussions on the agenda on the basis of the information indicating the discussions on the specific agenda by the personas. This allows the information processing apparatus 1 to more appropriately obtain information that facilitates understanding of the content of the discussions on the agenda.

The acquisition unit 31 also acquires, as the user information, information of each user U who has used a service in a specific category in an online Q&A service. This allows the information processing apparatus 1 to obtain more appropriate discussions on the agenda.

The acquisition unit 31 also acquires, as the user information, information of each user U who has performed a search with a specific search query in an online search service. This allows the information processing apparatus 1 to obtain more appropriate discussions on the agenda. The above is a detailed description of the embodiment of the present application based on the drawings. This is merely an example, and the present invention can be implemented in other modes with various modifications and improvements based on the knowledge of those skilled in the art, including the aspects described in the disclosure section of the invention.

In addition, the “unit” described above can be read as “means”, “circuit”, or the like. For example, the acquisition unit can be read as an acquisition means or an acquisition circuit.

According to one aspect of the embodiment, discussions on an agenda can be obtained more appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquisition unit that acquires user information that is information of each user who has performed a specific behavior in an online service;
a determination unit that determines a plurality of personas different from each other by clustering based on the user information acquired by the acquisition unit; and
a generation unit that causes generative AI to generate information indicating a discussion on a specific agenda by the personas based on information indicating the personas determined by the determination unit.

2. The information processing apparatus according to claim 1, wherein the user information comprises information indicating attributes of the user and information on the specific behavior performed by the user.

3. The information processing apparatus according to claim 2, wherein the generation unit inputs, to the generative AI as input information, information comprising instruction information that directs the discussion on the specific agenda by the personas determined by the determination unit, and causes the generative AI to generate information indicating the discussion by the personas.

4. The information processing apparatus according to claim 3, wherein the generation unit inputs information further comprising the persona's past utterance history on the specific agenda to the generative AI as the input information.

5. The information processing apparatus according to claim 3, further comprising a reception unit that receives agenda information that is information indicating an agenda, wherein
the generation unit causes the generative AI to generate information indicating the discussion by personas with an agenda indicated by agenda information by the reception unit as the specific agenda.

6. The information processing apparatus according to claim 5, wherein
the reception unit receives termination condition information indicating a termination condition for the discussion on the specific agenda, and
the generation unit inputs information to the generative AI as the input information, the information further comprising the termination condition information received by the reception unit in the instruction information.

7. The information processing apparatus according to claim 5, wherein
the reception unit receives constraint condition information indicating a constraint condition for discussion content by the personas, and
the generation unit inputs information to the generative AI as the input information, the information further comprising the constraint condition information received by the reception unit in the instruction information.

8. The information processing apparatus according to claim 5, further comprising a providing unit that provides a target person with information indicating the discussion on the specific agenda by the persona, wherein
the reception unit receives question information indicating a question by the target person, and
the generation unit inputs information to the generative AI as the input information, the information further comprising the question information received by the reception unit in the instruction information.

9. The information processing apparatus according to claim 5, wherein
the reception unit receives additional persona information indicating an additional persona being a persona other than the personas, and
the generation unit inputs information to the generative AI as the input information, the information comprising, as the instruction information, information instructing a discussion by the additional persona indicated by the additional persona information received by the reception unit and the personas.

10. The information processing apparatus according to claim 5, wherein the generation unit inputs information to the generative AI as the input information, the information further comprising information instructing a facilitator to proceed with a discussion in the instruction information, the facilitator facilitating the discussion by the personas.

11. The information processing apparatus according to claim 1, further comprising a creation unit that creates a mind map of the discussion on the specific agenda based on the information indicating the discussion on the specific agenda by the personas.

12. The information processing apparatus according to claim 1, wherein the acquisition unit acquires, as the user information, information of each user who has used a service in a specific category in an online Q&A service.

13. The information processing apparatus according to claim 1, wherein the acquisition unit acquires, as the user information, information of each user who has performed a search with a specific search query in an online search service.

14. An information processing method performed by a computer, the information processing method comprising:
acquiring user information that is information of each user who has performed a specific behavior in an online service;
determining a plurality of personas different from each other by clustering based on the user information acquired at the acquiring; and
causing generative AI to generate information indicating a discussion on a specific agenda by the personas based on information indicating the personas determined at the determining.

15. A non-transitory computer readable storage medium having stored an information processing program causing a computer to perform:
acquiring user information that is information of each user who has performed a specific behavior in an online service;
determining a plurality of personas different from each other by clustering based on the user information acquired at the acquiring; and
causing generative AI to generate information indicating a discussion on a specific agenda by the personas based on information indicating the personas determined at the determining.
